(19) United States
(12) Patent Application Publication
(10) Pub. No.: US 2012/0150542 A1
(43) Pub. Date: Jun. 14, 2012

(54) TELEPHONE OR OTHER DEVICE WITH SPEAKER-BASED OR LOCATION-BASED SOUND FIELD PROCESSING

(75) Inventor: Wei Ma, San Ramon, CA (US)

(73) Assignee: NATIONAL SEMICONDUCTOR CORPORATION, Santa Clara, CA (US)

(21) Appl. No.: 12/963,875

(22) Filed: Dec. 9, 2010

(51) Int. Cl. G10L 13/00

(52) U.S. Cl. 704/258; 704/E13.002

(57) ABSTRACT

A method includes obtaining audio data representing audio content from at least one speaker. The method also includes spatially processing the audio data to create at least one sound field, where each sound field has a spatial characteristic that is unique to a specific speaker. The method further includes generating the at least one sound field using the processed audio data. The audio data could represent audio content from multiple speakers, and generating the at least one sound field could include generating multiple sound fields around a listener. The spatially processing could include performing beam forming to create multiple directional beams, and generating the multiple sound fields around the listener could include generating the directional beams with different apparent origins around the listener. The method could further include separating the audio data based on speaker, where each sound field is associated with the audio data from one of the speakers.

### TECHNICAL FIELD

This disclosure is generally directed to audio devices. More specifically, this disclosure is directed to a telephone or other device with speaker-based or location-based spatial processing.

### BACKGROUND

Telephones and other devices that support conferencing features are widely used in businesses, homes, and other settings. Typical conferencing devices allow participants in more than two locations to participate in a teleconference. During a teleconference, audio data from the various participants is often mixed within a public switched telephone network (PSTN) or other network. Additional devices can also support supplementary functions during a teleconference. For instance, display projectors and video cameras can support video conferencing, and web-based collaboration software can allow participants to view each other's computer screens.

### BRIEF DESCRIPTION OF DRAWINGS

For a more complete understanding of this disclosure and its features, reference is now made to the following description, taken in conjunction with the accompanying drawings, in which:

FIG. 1 illustrates an example system supporting devices with speaker-based or location-based spatial processing according to this disclosure;

FIG. 2 illustrates an example device with speaker-based or location-based spatial processing according to this disclosure;

FIGS. 3 and 4 illustrate more specific examples of devices with speaker-based or location-based spatial processing according to this disclosure; and

FIG. 5 illustrates an example method for speaker-based or location-based spatial processing in devices according to this disclosure.

### DETAILED DESCRIPTION

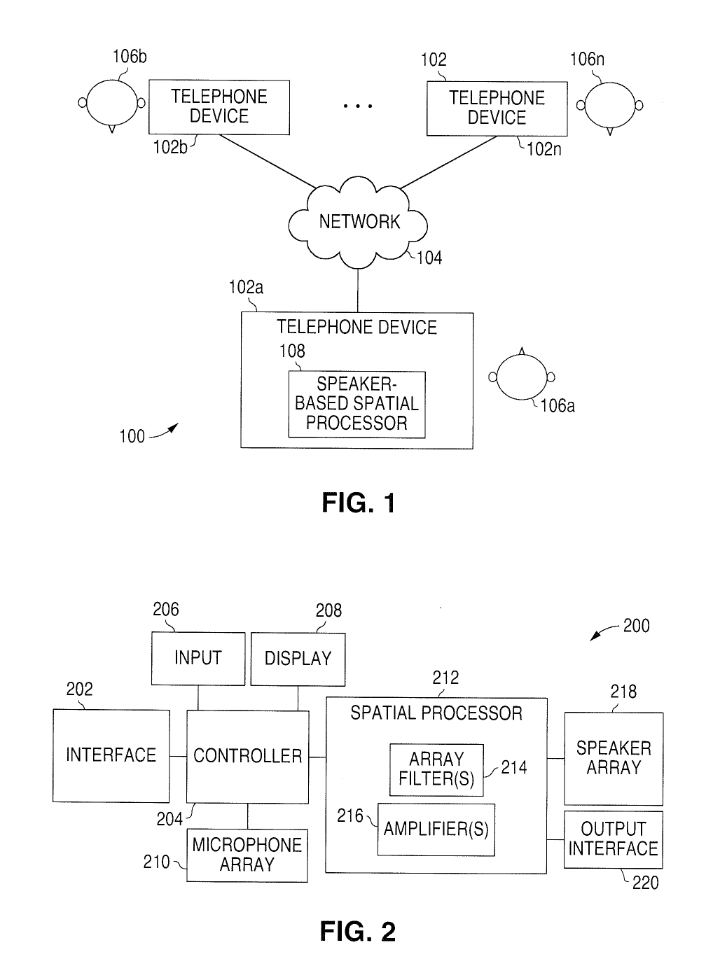

FIGS. 1 through 5, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example system 100 supporting devices with speaker-based or location-based spatial processing according to this disclosure. As shown in FIG. 1, the system 100 is a telecommunication system that includes devices 102a-102n with speaker-based or location-based spatial processing. In this example, the devices 102a-102n are telephonic devices that communicate with one another over at least one network 104. The telephone devices 102a-102n can exchange at least audio data with one another during telephone calls, including conference calls. Note that the term “telephone” broadly includes any telephonic device, including standard telephonic devices, Internet Protocol (IP) or other data network-based telephonic devices, computers or other devices supporting Voice over IP (VoIP) or other voice services, or any other devices that provide audio communication services.

Two or more telephone devices 102a-102n support audio exchanges between two or more participants 106a-106n during a telephone call or conference call. In general, a “telephone call” involves two or more telephone devices 102a-102n, while a “conference call” is a telephone call that involves at least three telephone devices 102a-102n. In this document, a telephone “call” generally refers to a communication session in which at least audio data is exchanged between endpoints in a real-time or substantially real-time manner.

Each of the telephone devices 102a-102n supports telephone calls involving local and remote participants 106a-106n. For example, from the perspective of the telephone device 102a, at least one participant 106a is a local participant, and all remaining participants are remote participants. From the perspective of the telephone device 102b, at least one participant 106b is a local participant, and all remaining participants are remote participants. During a telephone call, the telephone device 102a can provide outgoing audio data from its local participant(s) to the telephone device(s) used by the remote participant(s). The telephone device 102a can also receive incoming audio data from the telephone device(s) used by the remote participant(s) and present the incoming audio data to its local participant(s).

The network 104 transports audio data and optionally other data (such as video data) between the telephone devices 102a-102n. In some embodiments, the network 104 supports the separate streaming of audio data from different telephone devices 102a-102n. For example, the network 104 could transport audio data provided by the telephone device 102b to the telephone device 102a separate from audio data provided by the telephone device 102n. This could be done in any suitable manner. For instance, the network 104 could represent an IP network that transports IP packets, an Asynchronous Transfer Mode (ATM) network that transports ATM cells, a frame relay network that transports frames, or any other network that transports data in blocks. For ease of explanation, the term “packet” and its derivatives refer to any block of data sent over a network. In these embodiments, a telephone device 102a-102n could communicate over one or more data connections with the network 104. Note, however, that other types of networks 104 could also be used. For instance, the network 104 could represent a circuit-switched network, such as a public switched telephone network (PSTN). In these embodiments, a telephone device 102a-102n could communicate over multiple circuits, where each circuit is associated with a different remote participant. In other embodiments, the separate streaming of audio data from remote participants may not be supported by the network 104. In general, any suitable network or combination of networks could be used to transport data between the telephone devices 102a-102n.

In this example, at least one of the telephone devices 102a-102n includes a speaker-based spatial processor 108. The speaker-based spatial processor 108 generates spatial effects, such as sounds fields, that vary based on the source (speaker) of incoming audio data. For example, one or more beams of audio energy from the telephone device 102a may contain audio content from the remote participant 106b, while one or more different beams of audio energy from the telephone device 102a may contain audio content from the remote participant 106n. The beams can be sent in different directions from the telephone device 102a, so each beam has at least one spatial characteristic (such as apparent origin) that is unique for its particular remote participant. From the perspective of the local participant 106a, the audio content from different remote participants would appear to originate from different locations around the local participant 106a. The speaker-based spatial processor 108 performs the processing or other functions needed to provide the desired spatial effects.

The generation of the sounds fields or other spatial effects could be based on any suitable criteria. For example, the spatial processing could be location-based, meaning audio data coming from different locations can be associated with different sound fields. In general, “location-based spatial processing” would typically be a subset of “speaker-based spatial processing” since it is unlikely that the same speaker would be simultaneously present in multiple locations during the same telephone call.

The speaker-based spatial processor 108 could use any suitable technique to provide the desired spatial effects. For example, in some embodiments, the spatial processor 108 performs beam forming to direct different beams of audio energy in different directions. The spatial processor 108 could also perform crosstalk cancellation to reduce or eliminate crosstalk between different sound fields. Note that while beam forming is one type of speaker-based spatial processing that could be used, other types of spatial processing could also be used. For instance, a local participant 106a may be using a headset during a telephone call. In that case, the speaker-based spatial processor 108 in the telephone device 106a could cause audio data from one remote participant to be presented in a left headphone and audio data from another remote participant to be presented in a right headphone. The speaker-based spatial processor 108 could also use a head-related transfer function (HRTF) during the spatial processing.

In general, the speaker-based spatial processor 108 includes any suitable structure for providing spatial processing to at least partially separate audio content from different speakers. The spatial processor 108 could, for example, include a digital signal processor (DSP) or other processing device that performs the desired spatial signal processing. The spatial processor 108 could also include various filters that filter audio data to provide desired beam forming or other spatial cues, where the filters operate using filter coefficients provided by a processing device or other control device.

Although not shown, one or more of the telephone devices 102a-102n could include additional functionality. For instance, the telephone devices 102a-102n could support noise cancellation functions that reduce or prevent noise from one participant (or his or her environment) from being provided to the other participants, as well as echo cancellation functions. Also, the functionality of the telephone devices 102a-102n could be incorporated into larger devices or systems. For example, a telephone device 102a-102n could be incorporated into a video projector device that supports the exchange of video data during video conferences. As another example, a telephone device 102a-102n could be implemented using a desktop, laptop, tablet, or other computing device. In these embodiments, the speaker-based spatial processor 108 could be implemented using the processing unit of the computing device, and additional functions (such as web-based screen sharing) can be implemented by the processing unit.

Note that the use of the speaker-based spatial processing is not limited to just times when a telephone call is occurring. For example, when an incoming call is received at the telephone device 102a, the telephone device 102a can generate a unique sound field, such as a notification generated in a specific direction. The unique sound field could depend on various factors, such as the identity of the calling party, the phone number of the calling party, or a category associated with the calling party (like “work” or “home”).

Also note that the use of the speaker-based spatial processing is not limited to use with just telephonic devices. For example, the speaker-based spatial processor 108 could be used within a gaming console or other entertainment-related device (including a computer executing a gaming application). As a particular example, the spatial processor 108 could be used in a video projector of a person's entertainment center. In these types of embodiments, the speaker-based spatial processor 108 could be used to allow a listener to hear sounds from other “talkers” (whether real people in remote locations or simulated or recorded voices).

The use of speaker-based spatial processing can provide various benefits or advantages depending on the implementation. In many conventional call conferencing systems, audio data is mixed within a network, and it is often difficult for a listener to distinguish between multiple talkers during a conference call. Also, separate accounts are typically required for sharing visual and audio content, and one account typically cannot be used to manage the other account (such as when a telephone account cannot be used to manage a web-based screen sharing account). In addition, noise from any participant's location is usually mixed and provided to all other participants, and participants typically cannot control or balance the channel gain applied to other individual participants.

In accordance with this disclosure, the use of speaker-based spatial processing can help provide positional information in a multiple-talker environment. In other words, the perceived location of audio content gives a clue to a listener about the source of the audio content. This could help to increase the ease of using the telephone device 102a since the local participant may more easily distinguish the sources of the audio data being presented by the telephone device 102a. It can also help to increase meeting productivity and management.

Further, the spatial processing can be used to equalize incoming channels of audio data based on their volumes and background noises, as well as reduce far-end noise on certain participants' connections. This could be achieved, for instance, when VoIP technology is used to transport the audio data between telephone devices 102a-102n. Individual channels could also be muted so that a local participant can speak or listen to a subset of remote participants.

In addition, noise and echo cancellation can be performed, such as to reduce fan noise. Local acoustic echo can also be reduced or cancelled easier since beam forming is used to direct or focus sound to specific areas. This can help to provide better intelligibility and noise reduction during a telephone call and achieve better audio quality (such as from 200 Hz-20 kHz).

Although FIG. 1 illustrates one example of a system 100 supporting devices with speaker-based or location-based spatial processing, various changes may be made to FIG. 1. For example, the system 100 could include any number of telephones or other devices supporting speaker-based spatial processing, and not all of the telephone devices may support speaker-based spatial processing. Also, as noted above, the telephone devices may be stand-alone devices or incorporated into other devices or systems. In addition, FIG. 1 illustrates one operational environment where speaker-based spatial processing functionality can be used. This functionality could be used in any other suitable device or system (regardless of whether that device or system is used for telecommunications).

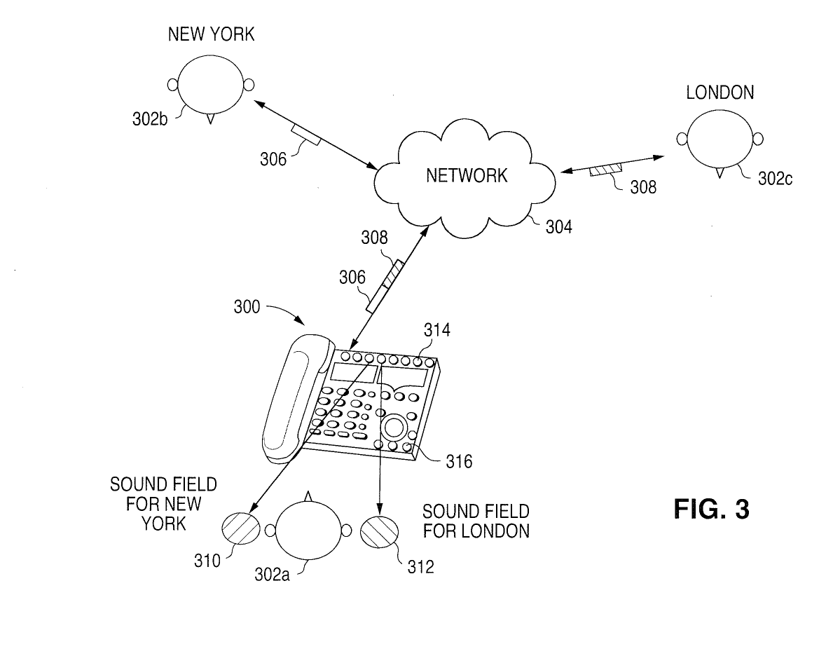

FIG. 2 illustrates an example device 200 with speaker-based or location-based spatial processing according to this disclosure. In this example, the device 200 includes at least one interface 202, which obtains audio data. For example, the interface 202 could represent a network connection that facilitates communication over a network (such as the network 104). The network connection could include any suitable structure for communicating over a network, such as an Ethernet connection or a telephone network connection. The interface 202 could also represent a wireless interface that receives data over a wireless communication link. The interface 202 could further represent an interface that receives audio data from a local source, such as an optical disc player. The interface 202 includes any suitable structure for obtaining audio information from a local or remote source.

A controller 204 can receive incoming data and provide outgoing data through the interface 202. The controller 204 also performs various functions related to the generation of speaker-based spatial cues. The controller 204 further provides data to or receives data from a user, such as via one or more input devices 206, a display 208, and a microphone array 210. As particular examples, during a telephone call, the controller 204 can provide outgoing audio data from the microphone array 210 to the interface 202 for communication over a network. The controller 204 can also perform echo and noise cancellation or other functions related to the outgoing audio data.

The controller 204 can further receive incoming audio data via the interface 202, separate the audio data based on source (speaker), and output the incoming audio data for presentation to a local participant. The controller 204 can use any suitable technique to separate the incoming audio data based on source. For example, packets of audio data sent over the network 104 could include packet origination addresses that identify the source devices that provided the packets. The controller 204 could use these origination addresses to separate the incoming audio data. Note, however, that the controller 204 could use any other suitable technique to separate the incoming audio data based on source.

The controller 204 includes any suitable structure for separating audio data based on source. For example, the controller 204 could include a microprocessor, microcontroller, field programmable gate array (FPGA), or application specific integrated circuit (ASIC). The input device 206 includes any suitable structure(s) for receiving user input, such as a keypad, keyboard, mouse, remote control, unit, or joystick. The display 208 includes any suitable structure for visually presenting information to a user, such as a light emitting diode (LED) display or a liquid crystal display (LCD). The microphone array 210 includes any suitable structures for collecting audio information, and any number of microphones could be used (including a single microphone).

Incoming audio data separated by the controller 204 is provided to a spatial processor 212, which in this example implements beam forming using one or more array filters 214 and one or more amplifiers 216. The array filters 214 are used to filter audio data in order to implement beam forming or other sound enhancement techniques to produce one or more desired audio effects. For example, the array filters 214 could operate using filter coefficients, which can be set or modified to provide the desired audio effects (such as a desired beam pattern). Specific examples of this particular functionality are provided in U.S. patent application Ser. No. 12/874,502 filed on Sep. 2, 2010 (which is hereby incorporated by reference). However, any other or additional beam forming or other spatial processing techniques for producing one or more desired audio effects could be implemented by the spatial processor 212.

The one or more audio amplifiers 216 amplify the audio signals output by the array filters 214. The audio amplifiers 216 include any suitable structures for amplifying audio signals. As particular examples, the audio amplifiers 216 could represent Class AB, B, D, G, or H amplifiers.

Audio signals output by the spatial processor 212 can be presented to one or more local participants using a speaker array 218 or an output interface 220. The speaker array 218 outputs audio energy that can be perceived by the local participant(s), where the audio energy has desired sound fields or other spatial effects. In some embodiments, the speaker array 218 generates different directional beams of audio energy aimed in different directions. The speaker array 218 generally includes multiple speakers each able to generate audio sounds. Each speaker in the speaker array 218 could include any suitable structure for generating sound, such as a moving coil speaker, ceramic speaker, piezoelectric speaker, subwoofer, or any other type of speaker. The speaker array 218 could include any number of speakers, such as four to eight speakers in a six-inch array.

The output interface 220 generally represents any suitable structure that provides audio content to an external device or system. The output interface 220 could, for instance, represent a jack capable of being coupled to a pair of headphones. However, the output interface 220 could represent any other suitable wired or wireless interface to an external device or system.

Note that in this embodiment of the device 200, it is assumed that the device 200 is used to present audio data associated with a telephone call. However, this need not be the case. For example, the device 200 can be used in a projector of an entertainment center, a gaming console, or other device in which audio content from different “speakers” is actually retrieved from a storage medium (like an optical disc).

Although FIG. 2 illustrates one example of a device 200 with speaker-based or location-based spatial processing, various changes may be made to FIG. 2. For example, the embodiment of the spatial processor 212 shown in FIG. 2 is for illustration only. The spatial processor 212 could include any other or additional structure(s) for providing beam forming or other spatial effects. Also, the functional division shown in FIG. 2 is for illustration only. Various components in FIG. 2 could be combined, omitted, further subdivided, or rearranged and additional components could be added according to particular needs. As a specific example, the controller 204 and the spatial processor 212 could be combined into a single functional unit, such as a single processing device.

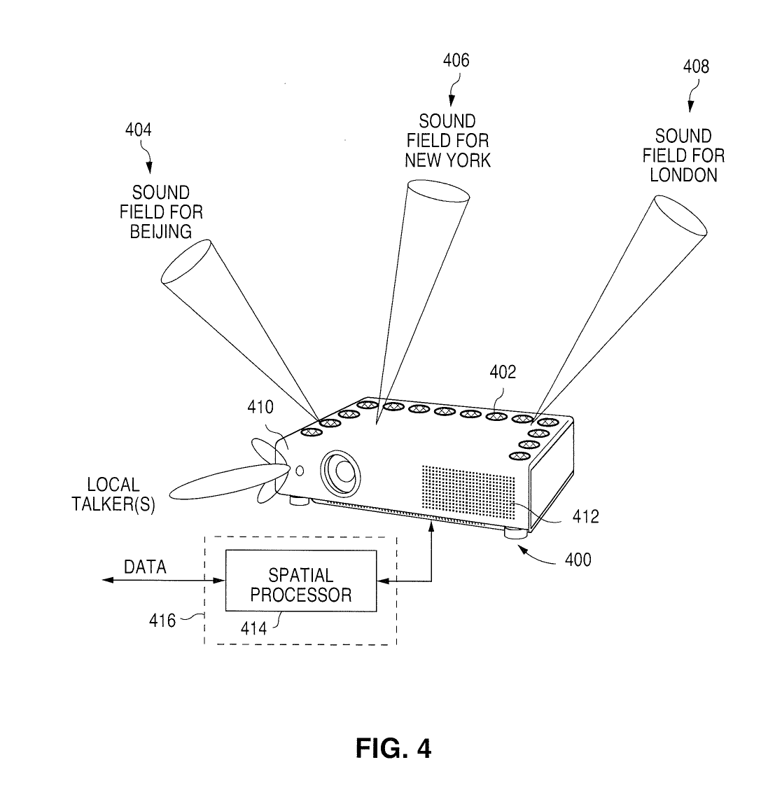

FIGS. 3 and 4 illustrate more specific examples of devices 300 and 400 with speaker-based or location-based spatial processing according to this disclosure. As shown in FIG. 3, the device 300 represents a desktop telephone that supports telephone calls, including in this example a conference call between a local participant 302a and two remote participants 302b-302c. The remote participants 302b-302c are shown as being located in different cities, although this need not be the case. The device 300 communicates over a network 304.

In this example, packets 306 containing audio data from the remote participant 302b are sent over the network 304 to the device 300, and packets 308 containing audio data from the remote participant 302c are sent over the network 304 to the device 300. The device 300 can separate the packets 306-308 based on, for example, the origination address contained in the packets 306-308, although other suitable approaches could be used.

The device 300 uses the incoming packets 306-308 to generate two sound fields 310-312. In this example, the sound field 310 is formed to the left of the local participant 302a, and the sound field 312 is formed to the right of the local participant 302a. The sound fields 310-312 are generated using a speaker array 314. Here, the sound fields 310-312 are associated with different remote participants 302b-302c. As a result, the local participant 302a effectively hears the remote participants 302b-302c on different sides of the local participant 302a. This can help the local participant 302a to more easily distinguish between talkers during the conference call.

As noted above, the device 300 can support various other functions. For example, the device 300 can allow the local participant 302a to individually mute different channels or change the volume of individual channels. The device 300 could also use a microphone array 316 to perform noise or echo cancellation functions. The device 300 could further allow the local participant 302a to make any other desired changes to the sound fields generated by the device 300.

As shown in FIG. 4, a video projector 400 supports video conferencing. The video projector 400 includes a speaker array 402, which generates different sound fields 404-408 based on the source of incoming audio data. Here, the different sound fields 404-408 are generated in different directions from the video projector 400, which can help a local participant more easily distinguish between talkers. Also, a microphone array 410 supports echo and noise cancellation. This may be useful, for instance, when performing active noise cancellation to cancel noise (like sounds or vibrations) from a fan 412 within the video projector 400.

A spatial processor 414 supports functions such as mixing, beam forming, or other spatial processing effects. Although shown as residing outside of the video projector 400, the spatial processor 414 could be integrated into the video projector 400. Moreover, the spatial processor 414 could be powered in any suitable manner. For example, the spatial processor 414 could be powered over an Ethernet connection using Power over Ethernet (PoE).

In particular embodiments, the spatial processor 414 could be incorporated into another device 416 that is separate from the video projector 400. For example, the device 416 could represent a desktop computer, laptop computer, tablet computer, mobile smartphone, or personal digital assistant (PDA). The device 416 could also be coupled to the video projector 400 using any suitable interface, such as a Universal Serial Bus (USB) interface. Video or other visual data from the device 416 could be provided to the projector 400 for presentation, and audio data could be provided to the spatial processor 414 for processing before being provided to the projector 400. Note, however, that if the spatial processor 414 is included within the video projector 400, the device 416 could simply provide the audio data to the projector 400 over the USB or other interface.

Although FIGS. 3 and 4 illustrate more specific examples of devices 300 and 400 with speaker-based or location-based spatial processing, various changes may be made to FIGS. 3 and 4. For example, as noted above with respect to FIGS. 1 and 2, the spatial processing performed by the devices 300 and 400 could vary and include different features. Also, features of one or more devices 102a-102n, 200, 300, 400 described above could be used in other devices described above, such as the cancellation of local fan noise.

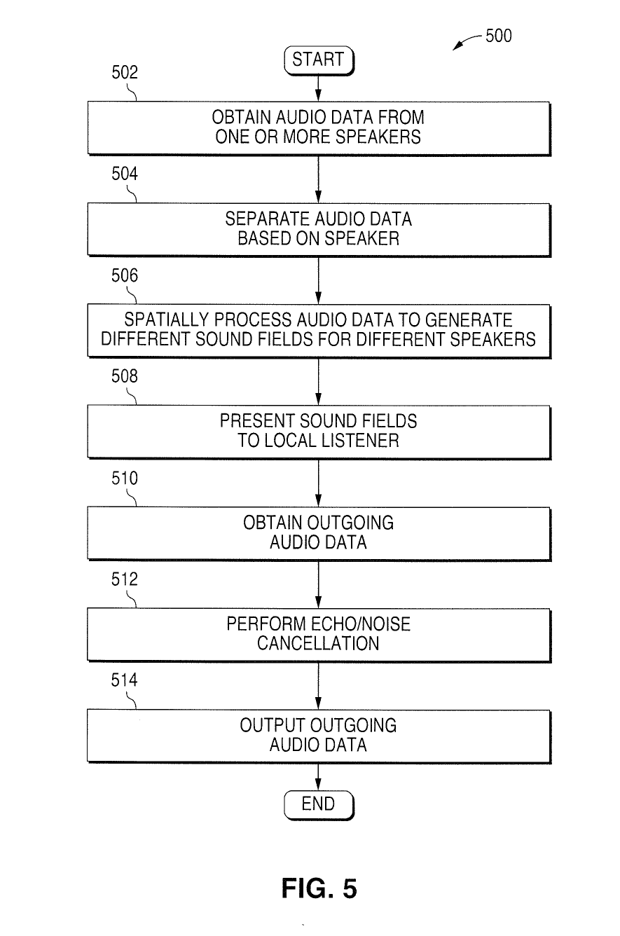

FIG. 5 illustrates an example method 500 for speaker-based or location-based spatial processing in devices according to this disclosure. As shown in FIG. 5, audio data from one or more speakers is obtained at step 502. In a telephonic device, this could include receiving incoming audio data from one or more remote participants over a network. In a gaming or entertainment device, the audio data could be received over a network, or the audio data for one or more real or simulated speakers could be retrieved, such as from a local optical disc, computer memory, or other storage medium.

The audio data is separated based on speaker at step 504. In a telephonic device, this could include separating packets of audio data based on origination addresses. In a gaming or entertainment device, this could include separating audio data based on flags or other indicators identifying the speakers.

The audio data is spatially processed to generate different sound fields for different speakers at step 506, and the sound fields are presented to a local listener at step 508. This could include, for example, performing beam forming to generate different beams of audio energy containing audio content from different speakers. Each sound field can have one or more unique spatial characteristics (such as apparent original), where the characteristics differ based on the speaker.

If used to support bidirectional communication between the local listener and any remote participants, outgoing audio data is obtained at step 510, echo and noise cancellation is performed at step 512, and the outgoing data is output at step 514. This could include, for example, using a microphone array to cancel fan noise or other local noise and outputting the audio data over a network.

Although FIG. 5 illustrates one example of a method 500 for speaker-based or location-based spatial processing in devices, various changes may be made to FIG. 5. For example, steps 510-514 could be omitted if two-way communication is not needed. Also, spatial processing other than or in addition to beam forming could be performed. In addition, while shown as a series of steps, various steps in FIG. 5 could overlap, occur in parallel, occur in a different order, or occur multiple times.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases that have been used within this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like.

While this disclosure has described certain embodiments and generally associated methods, alterations and permutations of these embodiments and methods will be apparent to those skilled in the art. Accordingly, the above description of example embodiments does not define or constrain this invention. Other changes, substitutions, and alterations are also possible without departing from the spirit and scope of this invention as defined by the following claims.

What is claimed is:

1. A method comprising:
obtaining audio data representing audio content from at least one speaker;
spatially processing the audio data to create at least one sound field, wherein each sound field has a spatial characteristic that is unique to a specific speaker; and
generating the at least one sound field using the processed audio data.

2. The method of claim 1, wherein:
the audio data represents audio content from multiple speakers; and
generating the at least one sound field comprises generating multiple sound fields around a listener.

3. The method of claim 2, wherein:
spatially processing the audio data comprises performing beam forming to create multiple directional beams; and
generating the multiple sound fields around the listener comprises generating the directional beams with different apparent origins around the listener.

4. The method of claim 2, further comprising:
separating the audio data based on speaker;
wherein each sound field is associated with the audio data from one of the speakers.

5. The method of claim 4, wherein:
obtaining the audio data comprises receiving packets of audio data over a network; and
separating the audio data comprises separating the packets based on origination addresses in the packets.

6. The method of claim 1, wherein obtaining the audio data comprises receiving the audio data over a network, the audio data associated with one or more remote participants in a telephone call.

7. The method of claim 1, wherein:
the audio data represents audio content from a single speaker; and
generating the at least one sound field comprises generating a single sound field around a listener, the single sound field having an apparent destination that varies based on at least one of: an identity of the single speaker, a phone number of the single speaker, and a category associated with the single speaker.

8. The method of claim 1, wherein generating the at least one sound field comprises using at least one of: a speaker array and an output interface to a set of headphones.

9. An apparatus comprising:
an interface configured to obtain audio data representing audio content from at least one speaker; and
a processing unit configured to spatially process the audio data to create at least one sound field, wherein each sound field has a spatial characteristic that is unique to a specific speaker.

10. The apparatus of claim 9, wherein:
the interface is configured to obtain audio data representing audio content from multiple speakers; and
the processing unit is configured to create multiple sound fields around a listener.

11. The apparatus of claim 10, wherein the processing unit is configured to perform beam forming to create multiple directional beams with different apparent origins around the listener.

12. The apparatus of claim 10, wherein the processing unit comprises:
one or more array filters configured to filter the audio data, each array filter having one or more filter coefficients selected to provide a desired beam pattern; and
one or more amplifiers configured to amplify the filtered audio data.

13. The apparatus of claim 10, further comprising:
a controller configured to separate the audio data based on speaker;
wherein the processing unit is configured to create the sound fields such that each sound field is associated with the audio data from one of the speakers.

14. The apparatus of claim 10, further comprising:
a microphone array configured to capture second audio data; and
a controller configured to perform echo and noise cancellation using the second audio data.

15. The apparatus of claim 9, wherein the interface and the processing unit form a part of one of: a desktop telephone and a video projector.

16. A system comprising:
a spatial processing apparatus comprising:
a first interface configured to obtain audio data representing audio content from at least one speaker; and
a processing unit configured to spatially process the audio data to create at least one sound field, wherein each sound field has a spatial characteristic that is unique to a specific speaker; and
at least one of:
a speaker array configured to generate the at least one sound field using the processed audio data for a listener; and
a second interface configured to output the processed audio data for presentation to the listener.

17. The system of claim 16, wherein:
the first interface is configured to obtain audio data representing audio content from multiple speakers; and
the processing unit is configured to create multiple sound fields.

18. The system of claim 17, wherein the processing unit is configured to perform beam forming to create multiple directional beams with different apparent origins around the listener.

19. The system of claim 17, wherein the spatial processing apparatus further comprises:
a controller configured to separate the audio data based on speaker;
wherein the processing unit is configured to create the sound fields such that each sound field is associated with the audio data from one of the speakers.

20. The system of claim 17, wherein the spatial processing apparatus further comprises:
a microphone array configured to capture second audio data; and
a controller configured to perform echo and noise cancellation using the second audio data.
